(19) United States
(12) Patent Application Publication
(10) Pub. No.: US 2009/0081332 A1
(43) Pub. Date: Mar. 26, 2009

(54) Filter Insertable into Bottle Cap

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/963,934

(22) Filed: Dec. 24, 2007

Related U.S. Application Data
(60) Provisional application No. 60/973,799, filed on Sep. 20, 2007.

(51) Int. Cl. B65B 29/02; A23L 2/52; B01D 35/02

(52) U.S. Cl. 426/72; 210/466; 210/467; 426/78

(57) ABSTRACT

A retrofittable filter that can be friction fit into a drinking cap for a bottle is disclosed. A filter having an element containing a material that can be released when exposed to a liquid is also disclosed. The material can be a flavoring material, a vitamin, a medication or any other additive that can be released when in contact with a liquid. A generally applicable retrofittable filter is disclosed. A retrofittable filter that only fits a certain design of drinking cap is provided. A kit containing a retrofittable filter that can be friction fit into a drinking cap is also provided.

### CROSS-REFERENCE TO RELATED APPLICATIONS

This application claims the benefit of U.S. Provisional Application No. 60/973,799, filed Sep. 20, 2007, which is incorporated herein by reference.

### BACKGROUND OF THE INVENTION

The present invention relates to the filtering and flavoring of liquids. More specifically it relates to the filtering and flavoring of liquids in bottles.

A growing awareness of the environmental impact of throw-away water bottles have stimulated the re-use of water bottles. Consumers refill bottles for instance from water coolers. Often though consumers may have to use tap water, which may have for instance a chlorine taste and adversely affects the taste of water. Also re-use of bottles may cause for instance bacterial growth in the bottle. While certain plastics have been designed to make bottles to inhibit bacterial growth in reuse, these are more expensive and not generally used by the industry or public.

There is also an ongoing awareness of the benefit of using vitamins and traces of certain minerals on a regular basis. Though people tend to drink water on a regular basis to re-hydrate, they often forget to take pills with vitamins on a regular basis. Providing vitamins and traces of required minerals to water that is consumed on a regular basis would be beneficial.

People often buy bottled water that have different additives for instance to enjoy different flavors. The opportunity to have flavored water refills from tap or water coolers is presently not widely available.

Filters for bottled water are known. Filters containing additives are also known. However a retrofittable filter that can be friction fixed in a bottle cap, the filter containing a flavor or health additive is novel and is currently not available.

Accordingly novel and improved filters are required that can be friction fit into a bottle cap to provide consumers who re-use their water bottle with clean water. Also novel and improved filters are required to provide clean water with tasteful and/or healthy additives.

### SUMMARY OF THE INVENTION

One aspect of the present invention presents a novel body for providing filtering and/or additive releasing capabilities to a bottle.

In accordance with an aspect of the present invention a retrofittable filter is provided for a liquid filled bottle having an opening in a drinking cap, comprising a body that can be friction fit into the drinking cap; and a filter operatively connected to the body to filter out material from the liquid in the body.

In accordance with a further aspect of the present invention a retrofittable filter is provided, wherein the drinking cap provided with the friction fit filter can be fastened on the liquid filled bottle.

In accordance with an aspect of the present invention a retrofittable filter is provided, wherein the friction fit filter can be removed from the cap manually by a person of ordinary strength without exerting extraordinary force.

In accordance with a further aspect of the present invention a retrofittable filter is provided further comprising an element containing a material that will be released from the element when exposed to a liquid.

In accordance with another aspect of the present invention a retrofittable filter is provided, wherein the material is a flavoring material.

In accordance with a further aspect of the present invention a retrofittable filter is provided, wherein the material is a vitamin.

In accordance with another aspect of the present invention a retrofittable filter is provided, wherein the material is a medication.

In accordance with a further aspect of the present invention a retrofittable filter is provided, wherein the material is encapsulated.

In accordance with another aspect of the present invention a retrofittable filter is provided, wherein the material is on a surface of the filter.

In accordance with a further aspect of the present invention a retrofittable filter is provided, wherein the material is impregnated in the filter.

In accordance with another aspect of the present invention a retrofittable filter is provided, further comprising one or more additional filters and a package containing the filters.

In accordance with a further aspect of the present invention a retrofittable element is provided for a liquid filled bottle having an opening in a drinking cap, comprising a body that can be friction fit into the drinking cap, a cavity in the body, and material in the cavity that can be released into the liquid as the liquid moves through the opening in the drinking cap.

In accordance with another aspect of the present invention a retrofittable filter is provided, further comprising the body having a lip that prevents the body from entering the bottle beyond the lip.

In accordance with a further aspect of the present invention a retrofittable filter is provided, wherein the lip has a diameter greater than an inside diameter of a neck of the bottle.

In accordance with another aspect of the present invention a retrofittable filter is provided, wherein the lip has a diameter not greater than an outside diameter of the neck of the bottle.

In accordance with a further aspect of the present invention a retrofittable filter is provided, further comprising the body having a filter.

In accordance with another aspect of the present invention a retrofittable filter is provided, wherein the material is a flavoring material.

In accordance with a further aspect of the present invention a retrofittable filter is provided, wherein the material is a vitamin.

In accordance with another aspect of the present invention a retrofittable filter is provided, wherein the material is a medication.

In accordance with a further aspect of the present invention a retrofittable filter is provided, wherein the material is encapsulated.

In accordance with another aspect of the present invention a retrofittable filter is provided, further comprising one or more additional elements and a package containing the elements.

### DESCRIPTION OF THE DRAWINGS

FIG. 1 is a diagram that illustrates an embodiment of a retrofittable filter in accordance with one aspect of the present invention.

FIG. 2 is another diagram that illustrates an embodiment of a retrofittable filter in accordance with an aspect of the present invention.

FIG. 3 is a diagram that illustrates another embodiment of a retrofittable filter in accordance with an aspect of the present invention.

FIG. 4 is another diagram that illustrates an embodiment of a retrofittable filter in accordance with an aspect of the present invention.

FIG. 5 is yet another diagram that illustrates an embodiment of a retrofittable filter in accordance with an aspect of the present invention.

FIGS. 6A, 6B, 6C and 6D are diagrams that illustrate yet another embodiment of a retrofittable filter in accordance with an aspect of the present invention.

FIG. 7 is a diagram that illustrates yet another embodiment of a retrofittable filter in accordance with an aspect of the present invention.

FIG. 8 is a diagram that illustrates yet another embodiment of a retrofittable filter in accordance with an aspect of the present invention.

FIG. 9 is a diagram that illustrates yet another embodiment of a retrofittable filter in accordance with an aspect of the present invention.

FIG. 10 is a diagram of a known drinking cap.

FIG. 11 is a diagram that illustrates yet another embodiment of a retrofittable filter in accordance with an aspect of the present invention.

FIG. 12 is a diagram that illustrates other embodiments of a retrofittable filter in accordance with an aspect of the present invention.

FIG. 13 is a diagram that illustrates yet another embodiment of a retrofittable filter in accordance with an aspect of the present invention.

FIG. 14 is a diagram that illustrates an embodiment of a kit in accordance with an aspect of the present invention.

FIG. 15 is a diagram that illustrates another embodiment of a kit in accordance with an aspect of the present invention.

FIG. 16 is a diagram that illustrates another embodiment of a retrofittable filter in accordance with an aspect of the present invention.

FIG. 17 is a diagram that further illustrates the embodiment of FIG. 16 of a retrofittable filter in accordance with an aspect of the present invention.

FIG. 18 is a diagram that illustrates yet another embodiment of a retrofittable filter in accordance with an aspect of the present invention.

FIG. 19 is a diagram that further illustrates the embodiment of FIG. 18 of a retrofittable filter in accordance with an aspect of the present invention.

FIG. 20 is a diagram that illustrates yet another embodiment of a retrofittable filter in accordance with an aspect of the present invention.

FIG. 21 is a diagram that further illustrates the embodiment of FIG. 20 of a retrofittable filter in accordance with an aspect of the present invention.

FIG. 22 is a diagram that further illustrates the embodiment of FIG. 20 of a retrofittable filter in accordance with an aspect of the present invention.

FIG. 23 is a diagram of a body of a retrofittable filter in accordance with an aspect of the present invention.

FIG. 24 is a diagram of a body of a retrofittable filter in accordance with another aspect of the present invention.

FIG. 25 is a diagram of a body of a retrofittable filter in accordance with yet another aspect of the present invention.

FIG. 26 is a diagram of a body of a retrofittable filter in accordance with yet another aspect of the present invention.

FIG. 27 is a diagram of a body of a retrofittable filter in accordance with yet another aspect of the present invention.

FIG. 28 is a diagram of a body of a retrofittable filter in accordance with yet another aspect of the present invention.

### DESCRIPTION OF A PREFERRED EMBODIMENT

The present invention relates to the field of bottled water, filters and added flavors. In previous patents and applications the inventor has discussed ways in which to design a cap that releases ingredients into bottled water. Part of the usage of bottled water is that consumers often reuse the bottles. While certain plastics have been designed to make bottles to inhibit bacterial growth in reuse, these are more expensive and not generally used by the industry or public.

The use of filters in re-used bottles may provide a better hygienic practice by filtering out undesirable elements. Adding additives to those filters which are released during drinking when the liquid such as water permeates the filter may add additional benefits to re-using bottles. Providing tasteful and healthy additives increases the choice that consumers have without adding substantial cost.

Filters for water bottles are known. These filters may include activated carbon for instance to be used for removing chlorine or for reducing the level of chlorine. Filters may also be used for reducing or stopping biological elements such as bacteria in the water. Providing additives to bottles of water such as flavoring, vitamins, minerals, and medication is also known. However retrofittable filters for water bottles which may also provide a controlled release of material are not known.

In accordance with one aspect of the present invention a retrofittable filter is provided which may be purchased separately by a consumer and fit by the consumer, for instance by friction fitting, into a drinking cap for instance with a closable spout.

One of the issues with water bottles is that they may use different type and sizes of caps with different type of spouts. In accordance with another aspect of the present invention a retrofittable filter for water bottles is provided which may fit in different types of bottle caps. The universality of a filter may be limited to the size of the opening of a bottle, and different size retrofittable filters are contemplated for different opening sizes.

Different bottlers and bottle manufacturers are known to produce different type of caps with drinking spouts, even if bottle openings are the same size. In accordance with a further aspect of the present invention filters are provided that fit a specific type of cap, thus providing a valuable market differentiator to a company using a specific cap with drinking spout.

In accordance with another aspect of the present invention a retrofittable filter may be like a strainer that may not remove chlorine but certainly will prevent particles to be consumed by a consumer. The filter may also be a filter that removes small elements such as chlorine and requires for instance active carbon and the filter may have a greater size that needs to fit inside the bottle.

In accordance with a further aspect of the present invention a filter is enabled to provide a controlled release of additives such as flavoring, vitamins, medication, drugs or any other additive. Controlled release in this context means that the material to be released is contained in such a way that contact with water will not release the majority of the material all at once. For instance sugar is highly soluble in water. Bringing sugar in contact with water will quickly dissolve the sugar crystals. Accordingly the materials that have to be released in the water should either have a solubility in water that is significantly lower than sugar, so the material would dissolve slowly and in a more controlled way or the materials may be for instance micro-encapsulated in micro-capsules that dissolve relatively slowly.

In one embodiment one may impregnate a filter or part of a filter with materials to be released. In a different embodiment one may provide as a separate part of the filter, such as for instance an element inside a filter (for instance a tubular filter) an amount of material that contains the material to be released. Such element may preferably be provided as a porous material or material with channels that allow the water to pass through it and dissolve the additives to be released. In a further embodiment the material to be released may be contained in microcapsules that release the additives in a controlled way, or wherein the microcapsules are released from the element to enter the drinking stream and may release their content inside the body of the consumer.

In accordance with another aspect of the present invention a filter which may include an additive for slow release is provided as part of a kit. Such a kit in one embodiment comprises at least one filter and packaging. The packaging may include a blister pack, which may have a clear for instance plastic side which allows viewing the filter. The packaging may also comprise directions for use of the filter. It may also contain further information about the filter, additives, and/or the company. It may also contain a coupon for discount. The kit in a further embodiment may comprise a replacement cap that is enabled to receive a filter contained in the kit.

### Filter Embodiments

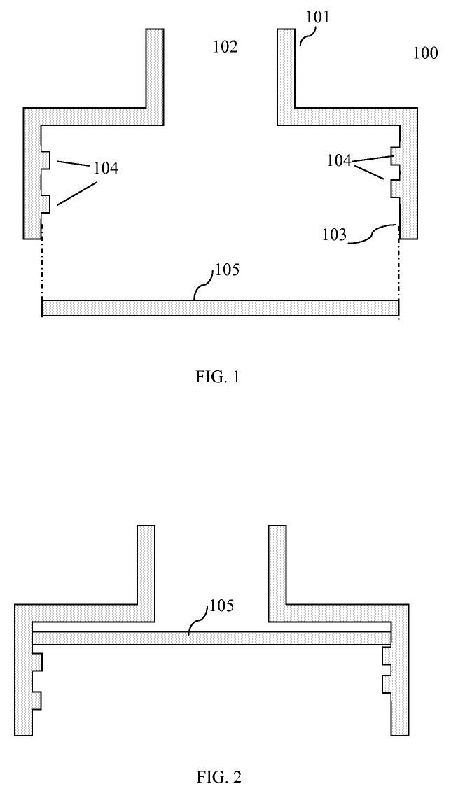

FIG. 1 shows a cross sectional diagram which is not to scale in its details of a bottle cap 100 with a spout 101. The spout has an opening 102 which allows the flow of liquid. The spout may have additional materials for instance for a valve or other purposes which are ignored for the current purpose. The cap may have a thread 104 which protrudes slightly into the opening. The thread allows the cap to be screwed onto the bottle. Also shown in FIG. 1 is a filter 105 which is a retrofittable filter. The purpose of the retrofittable filter is to be placed inside the cap as to only allow liquid to flow from below the filter through the filter through the opening of the spout 102 when the bottle cap is threaded on a bottle. The filter 105 may be a ring of relatively flexible material which can be bent, which will hold a filter which may also be made of relatively flexible material. In an embodiment the filter may be a mesh of fibers or of threads which will allow liquid to pass through but will stop particles of materials. The filter ring may also be made from the same material as the mesh.

FIG. 2 shows the filter 105 being fit into the cap. Because at least the filter ring can bend it can pass the obstacle of the thread and settle inside the cap. One may make the diameter of the filter slightly greater than the inner diameter of the cap to provide a tight fit. This may cause the filter ring to remain slightly bent or distorted when it is inside the cap. Sufficient room is left inside the cap to allow it to be screwed onto the bottle, thus creating a bottle with a filter cap.

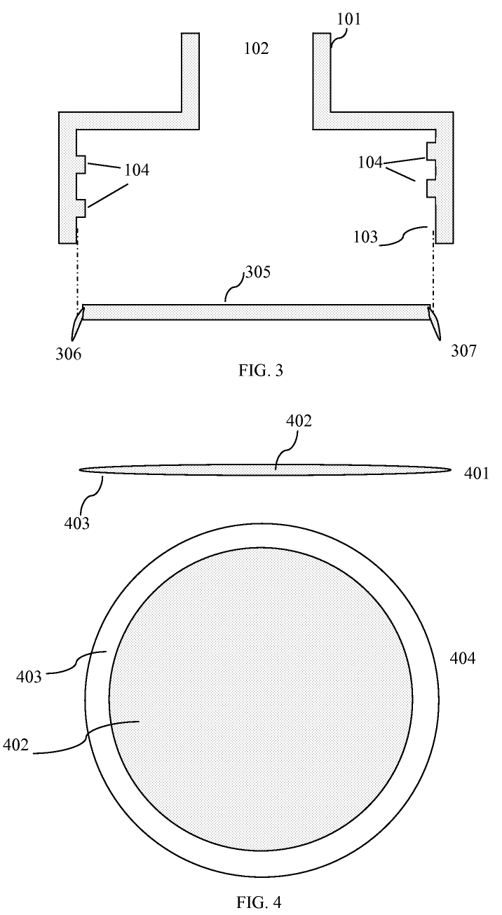

FIG. 3 shows another embodiment of a cap with a filter. Herein the filter 305 has an extended filter ring shown in cross-sectional diagram in FIG. 3. The extension, shown as 306 and 307 may be a thinner and more flexible extension of the filter ring. The extension may also be a thinner but larger ring than the filter ring which is fastened to the filter ring. Details of the extension are shown in FIG. 4. In FIG. 4 401 provides a cross-sectional view of the filter, wherein 402 is for instance the filter mesh and 403 is the ring. One can see how the ring becomes smaller and easier to bend and possibly to squeeze it into a thinner size. FIG. 4 404 shows a top view of the filter again showing 402 as the filter body or mesh and 403 as the ring.

FIG. 5 shows in cross-sectional diagram the filter with flexible ring forced into the cap with a spout. It shows the flexible and squeezable ring 403 being bent and squeezed by the inside of the cap, thus creating a barrier for the liquid and preventing the liquid from flowing around the filter and helping the filter to stay inside the cap by the friction of the ring with the cap.

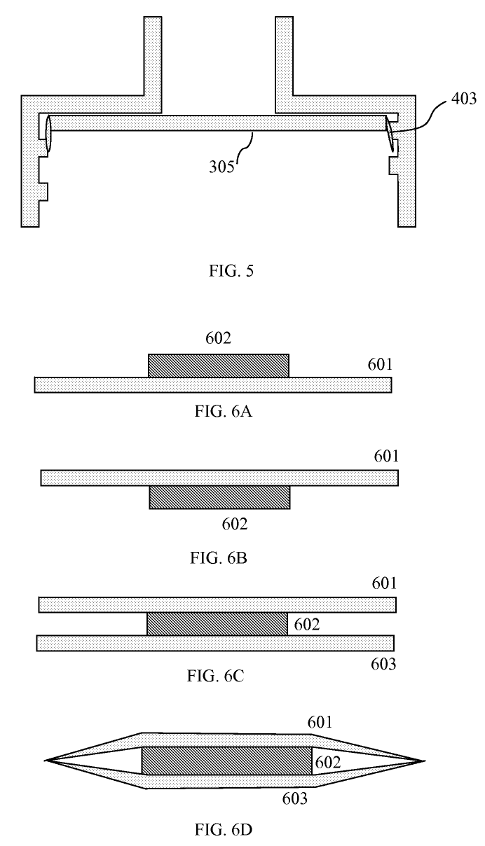

FIGS. 6A, 6B, 6C and 6D show in a diagram different configurations for a filter as provided above with for instance porous materials that contain additives which can be leached out by flowing water, thus bringing the additives which may be flavors, vitamins, medication or any other required additive into a liquid stream. It is assumed that the water flow during drinking is from bottom to top. In FIG. 6A for instance a material 602 which may be porous is placed on top of the filter 601. It should be understood that filter 601 can be any of the previously provided filter configurations. As water flows through the filter 601 and material 602 the material 602 will release the additive or the water may leach the additive out of material 602. FIG. 6B is a configuration wherein the material 602 with the additives is placed under the filter. This configuration may be useful if the material 602 is likely to release different size particles that may then be filtered out by the filter 601 and are prevented from being ingested.

One other configuration is wherein material is placed both on the top and on the bottom of the filter. Another configuration or embodiment is wherein the material 602 is placed between two filters 601 and 603. FIG. 6C shows the principle of such configuration. FIG. 6D shows in diagram how a shape of such a configuration or embodiment could potentially look. FIG. 6D may in one embodiment be a flexible meshed bag created by 601 and 603 filled with an additive carrying material that can be released by a liquid flow.

In a further embodiment a filter cartridge is used. Such a filter has a more extended body that may be covered by a membrane. The filter may contain filter material such as activated carbon. In general such a filter may have a vertical main channel to conduct water to the exit of the filter which may connect to the neck of the bottle. Entry of the liquid in a bottle may occur through channels that are positioned radial to the vertical axis of the filter. Other configurations are also possible and contemplated. A problem that is addressed as an aspect of the present invention is to provide such a filter as a retrofittable filter that fits in a drinking cap with a spout.

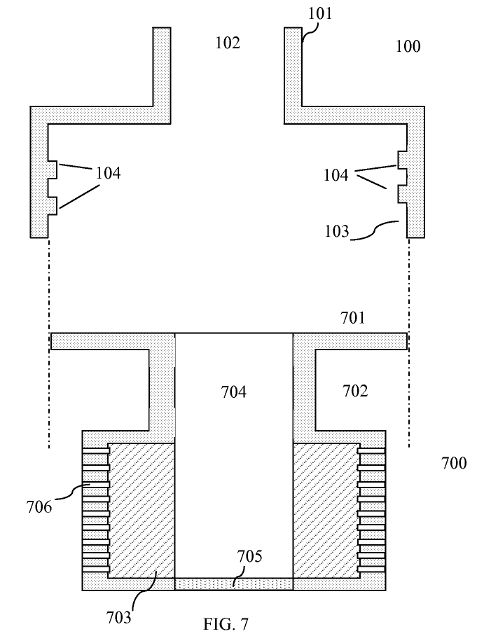

One embodiment of a retrofittable filter is shown in FIG. 7. FIG. 7 shows again a drinking cap with a spout 100. Herein 700 is in diagram the retrofittable filter. First of all the filter has to fit through the neck opening of the bottle. This means that its diameter should not be bigger than the bottle neck diameter. For illustrative purposes the filter or filter cartridge is assume to be tubular. However its horizontal cross-section may also be rectangular or a polygon as long it does not exceed the limits of the bottle neck. In fact a rectangular shape or a polygon shape may help to provide additional friction to hold the filter in the neck.

In accordance with an aspect of the present invention the filter should be friction fit into the bottle cap. One embodiment of such a configuration is shown in diagram in 700 of FIG. 7. The filter or filter cartridge has a rim or flange or lip or lip 701. As explained for the filter shown in for instance FIGS. 1-5 the flange or lip or lip or rim should be flexible enough to deform so it can fit into the cap 100, but strong enough that it will create friction with the cap so it can not fall out of the cap or be removed by exerting some force. The flange or lip or lip or rim should be thin enough so it will leave enough room within the cap to be screwed on to the bottle neck, thus creating a bottle with a drinking cap with a retrofittable filter. The flange or lip or lip or rim has of course a hole that will allow liquid to flow to the bottle neck. The flange or lip is connected to the body of the filter or filter cartridge by a filter neck 702. To facilitate insertion of the flange or lip into the cap it may be provided with a tapered shape.

The filter neck 702 allows room within the cap to connect to the thread of the bottle neck and the cap to be screwed onto the bottle neck. The neck preferably should extend beyond the inside vertical length of the cap to allow the cap to be sufficiently screwed on the bottle neck. The cartridge neck is connected to a cartridge body 703. One may increase the total active filter area by making the neck part of the filter. The size of the filter cartridge may be wider than the cartridge neck as long it does not exceed the diameter of the bottle neck. The cartridge body 703 has a flow channel 704 which channels the filtered water through the filter neck 702 and the flange or lip 701 to the drinking hole 102 in the drinking cap. The filter preferably has a closed end or blockage 705 that prevents unfiltered water to enter the channel 704 directly and makes sure that liquid from the bottle will go through the filter element. Liquid will enter the filter cartridge 703 through filter channels 706. The actual filter material in 703 is porous. Embodiments of filter materials are well known and may include different elements and components including active carbon and membranes and such embodiments are fully contemplated. One may then friction fit a filter into a cap and if so desired, remove the friction fit filter from the cap by pulling on the filter and for instance replace it with another filter. Accordingly one thus has an embodiment of a retrofittable or insertable filter, friction fit into a drinking cap of a water bottle.

### Fixation and Release of Additives

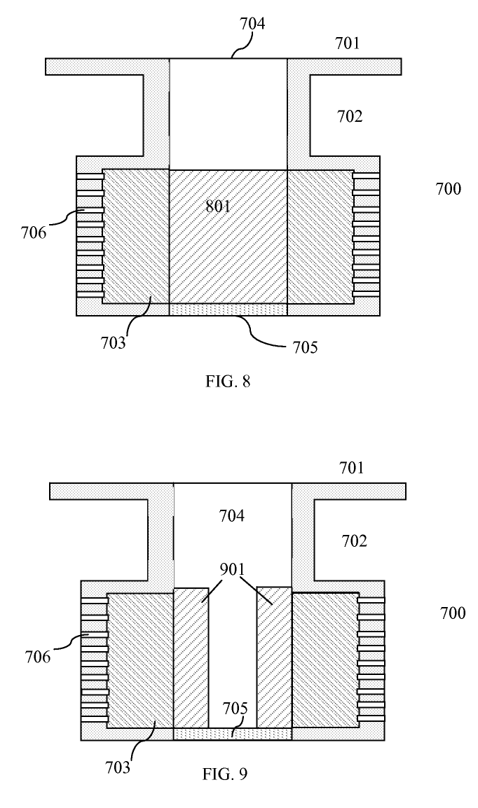

The fixation of additives of releasable additives, including flavoring, vitamins, medication is known and can be applied in an embodiment of the filters here provided. For instance an additive may be fixated in a porous material that will release the additive when exposed to a liquid. Such a material may be fibers woven into a fabric that is soaked in a solution with the additives. Such an element may not seriously limit the flow of liquid and may for instance be put in channel 704 of the filter cartridge. Such an element may be like a teabag containing micro-encapsulated additives. Such an element may also contain inert fillers to provide body to the element and make it fit in the channel. This is shown in FIG. 8 wherein 801 is an element with releasable additives, which may be micro-encapsulated and which may partially or completely fill channel 704.

In another embodiment the element containing the additives may be a porous material which may be made completely of additives or which has a fixed structure on which additives are fixated in a releasable manner wherein the additives or micro-encapsulated additives form a matrix which can be leached out by a liquid. An embodiment of such additive releasing structure is shown in FIG. 9. Such additive releasing element may be positioned as a lining 901 to the filter in one illustrative embodiment as shown in FIG. 9.

A filter may also be provided with known means to limit the amount of liquid remaining to soak the additive releasing element when a consumer is not drinking. Such means prevents the additives from being released in undesirable high concentrations.

Other Filter Shapes

There are proprietary drinking cap designs on the market that are being used on water bottles. One such design is for instance a cap that is covered by U.S. Pat. No. 5,975,369. One marketing approach for retrofittable filter would be to provide drinking cap specific filters. For instance one would still be able to fit a universal filter into such a cap, but specific additives or specific filter properties may only be available in a cap specific filter.

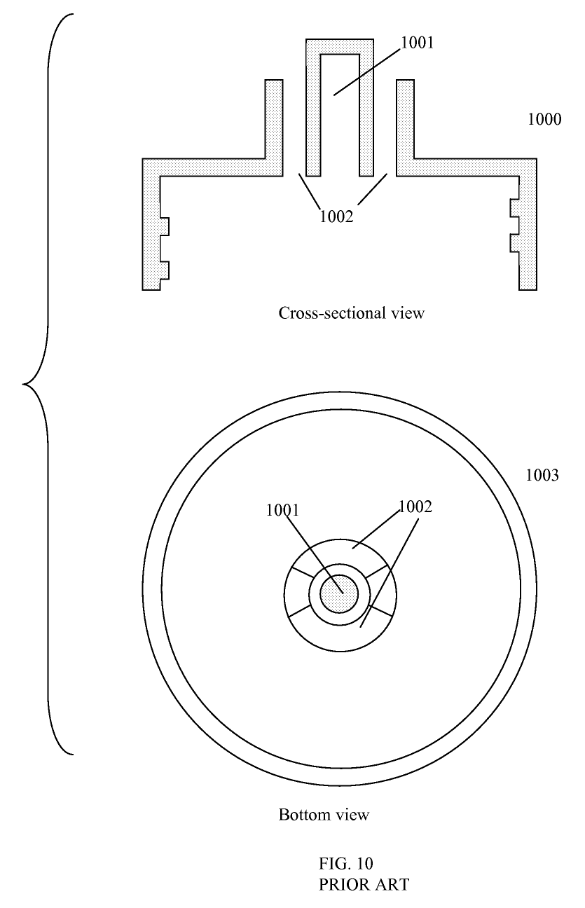

FIG. 10 shows in diagram as an illustrative example the cap of the above cited patent a cross-sectional view 1000 and a view 1003 from below. The cap has a small hollow tube 1001 that is used to fit a valve which is not shown. The cap also has two holes for liquid passages 1002. Both features can be used to friction fit a retrofittable filter.

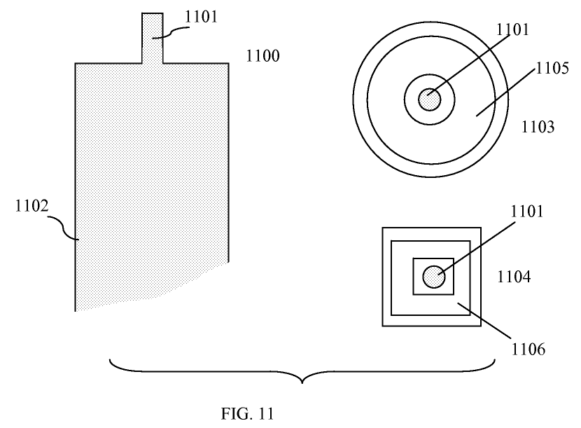

FIG. 11 shows in diagram an illustrative embodiment of a retrofittable filter 1100 that may be friction fit into the cap of FIG. 10. The filter has a protrusion 1101 attached to the body of the filter 1102. The protrusion 1101 will friction fit into tube 1001 of the cap of FIG. 10. The filter 1100 is shown in diagram from above in 1103 and 1104. Diagram 1103 shows a filter having a circular cross section shape wherein a flow channel 1105 is provided. Diagram 1104 shows a diagram of a filter having a rectangular cross section with flow channel 1106. The flow channels allow the filtered and additive added liquid to flow to and through the cap. Other shapes of the filters are possible.

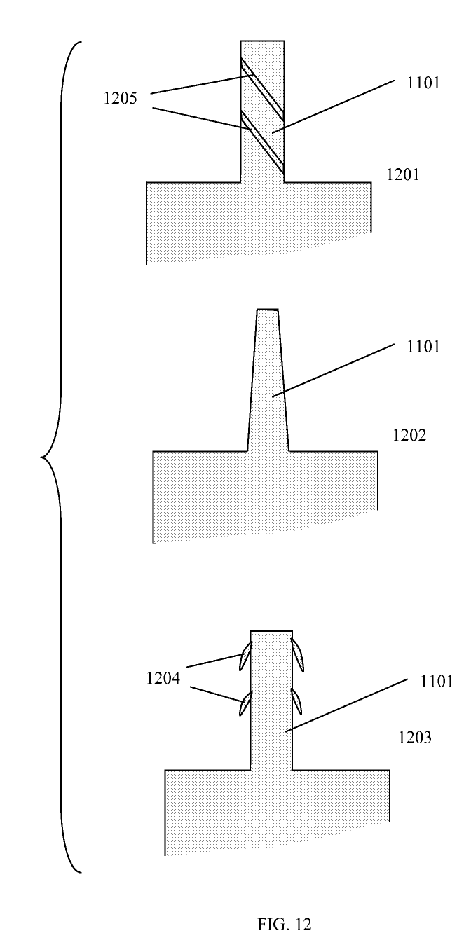

FIG. 12 shows in diagram 3 illustrative embodiments of the protrusion 1101 of a filter. Diagram 2101 shows a spiraling ridge 1205 of for instance flexible and squeezable material around the protrusion. With the protrusion smaller in diameter than the tube 1001 the protrusion will fit tightly into the tube, while the spiral ridge may require exerting force for removal of the filter. Diagram 1202 shows a tapered protrusion 1101 which will help to friction fit into the cap. Diagram 1103 shows protrusion 1101 with several flexible flaps (which may be a complete ring around the protrusion) 1204. Again when the protrusion 1101 is smaller than tube 1001 insertion will be fairly easy. However removal of the filter may require exerting force. Other embodiments are also possible and contemplated.

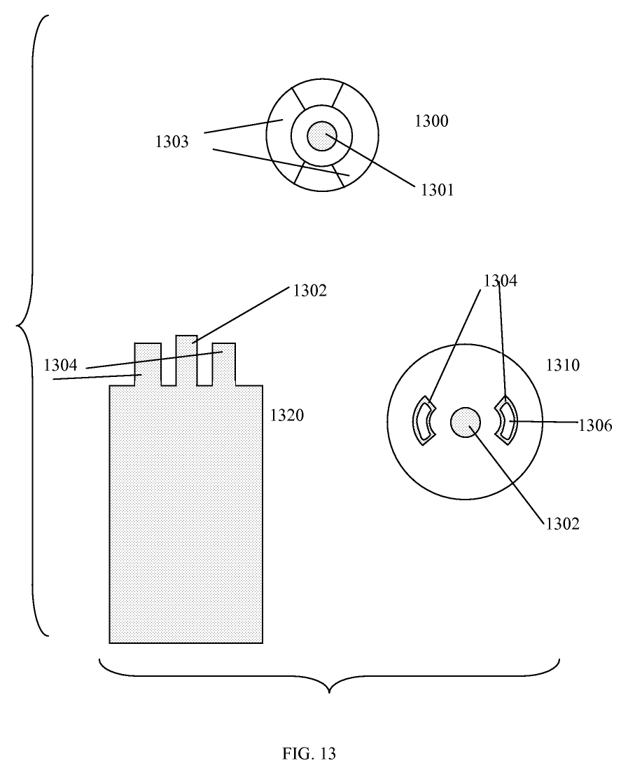

FIG. 13 shows in diagram a filter 1320 for the above drinking cap wherein further flow extensions 1304 are provided which provide a connection to the flow channel in the filter and have holes 1306 which allows the flow of liquid through the cap. Extensions 1304 fit into the holes 1303 in the cap 1300. The protrusion 1303 of the filter 1320 fits into the tube 1301 of the cap. Diagram 1310 is an above view of the filter 1320. Different configurations are possible and contemplated. Accordingly a retrofittable friction fit filter is provided that may fit exclusively into a certain drinking cap.

### A Retrofittable Filter Kit

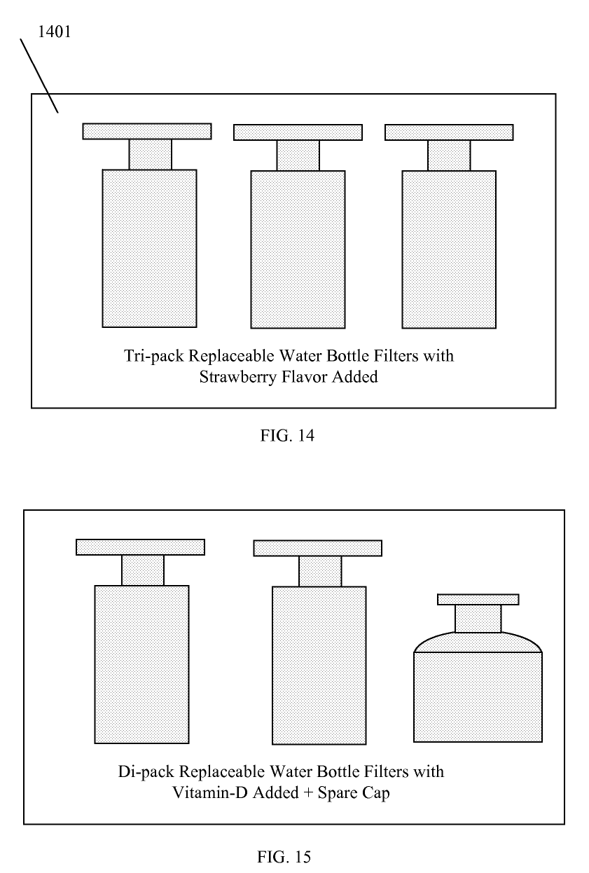

As a further aspect of the present invention a kit with a retrofittable filter is provided. Such a kit has at least one retrofittable filter that may further contain a releasable additive which may be a flavoring, a vitamin, a mineral, a medication or any other releasable additive, the filter enabled to friction fit into an existing drinking cap. The kit may also have 2 or more filters. A filter may be provided with a flavoring, a vitamin, a medication or with any other additive. The kit may also contain packaging. Such packaging may be carton or plastic or any other material packaging. The packaging may be totally or partially clear and transparent enabling a person to see its content. The kit may also contain directions for use. The kit may also contain promotional material for other purchases. Such promotional material may be a discount coupon. One illustrative example of a kit is shown in FIG. 14. Herein the kit has a carrier for instance made of carton with printed text and three filters with flavor additives. The kit may be covered with a clear transparent plastic cover. FIG. 15 is another illustrative embodiment of a kit similar to the example shown in FIG. 14 but with two filters and one cap of existing design provided wherein the filters will friction fit. Many other embodiments of a kit are possible and fully contemplated.

One characteristic of a retrofittable filter is that it can be removed from the drinking cap and replaced with a different filter.

### Further Embodiments

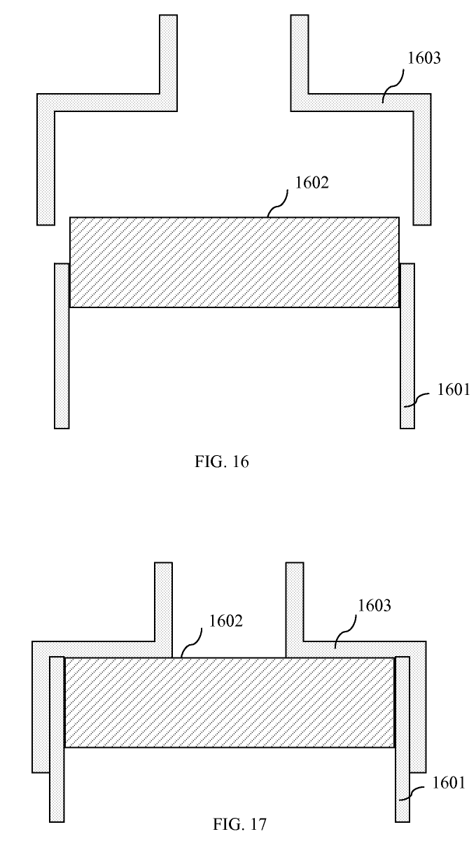

In a further embodiment one may use a body which may have cavities which can let pass a liquid from one side to another side of the body. This body, which may be of a flexible material can be friction fit into the neck of a bottle. This is shown in FIG. 16 in a cross-sectional diagram. Herein 1601 is a cross-sectional diagram of a bottleneck; 1603 is a cross-sectional diagram of a drinking cap and 1602 is the body with cavities which can be forced and friction fit into the bottle neck. The body is flexible enough so when its diameter is somewhat greater than the diameter of the bottleneck it can be deformed to fit into the bottleneck. The body can contain additives that can be leached out of or dissolved from the body by a liquid. The body may also act as a filter.

The additive material may be contained inside the body in its uncovered form. The additive material may also be contained in microencapsulated form.

In one embodiment the bottleneck 1601 and the cap 1603 have matching threads for screwing the cap onto the bottleneck.

The body 1602 may contain additives which will be leached out of or dissolved from the body when liquid is passing through. One may fill some or all of the cavities of the body with a material that will act as a filter. One may also make the diameter of the cavities small enough so that it will not let pass particles of a size greater than the cavities, so that the cavities act as a filter. The additives which are contained for release in the body should dissolve to a size smaller than the cavities so it can be leached out of or dissolved from the body 1602 by a passing liquid. FIG. 16 shows body 1602 being partially fit into the bottleneck.

In one embodiment the body 1602 is flexible enough so that it can be forced into the bottleneck. In a further embodiment the body 1602 is also resilient enough so that it maintains most of its shape under force so it can be forced into the bottleneck. If there is no resilience the body might just be deformed without moving into the bottleneck. For example FIG. 17 shows how screwing the cap 1601 onto bottleneck 1603 forces body 1602 into the bottleneck.

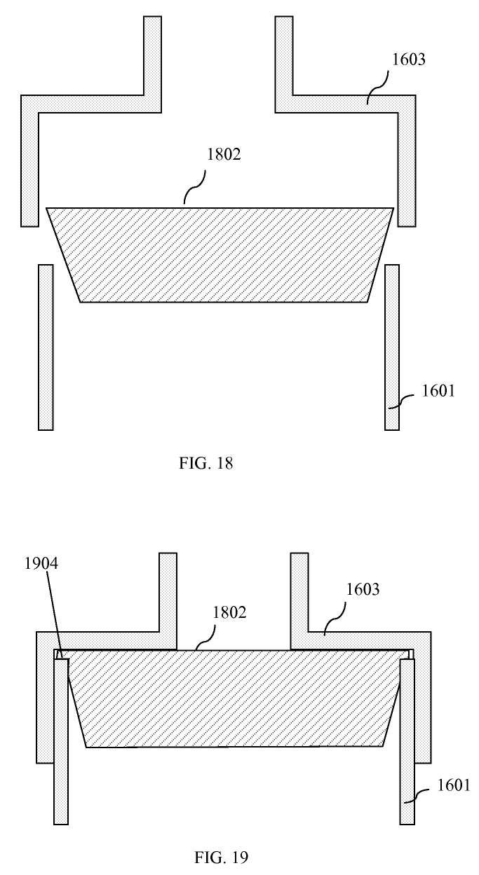

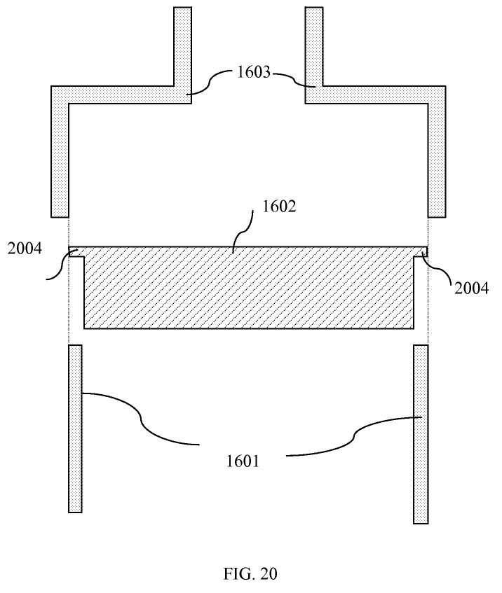

One may also force the body manually into the bottleneck. In order to make sure that the bottleneck first receives the body one may slightly taper the body, as is shown in diagram in FIG. 18 wherein the tapered body has numeral 1802. This is a cross-sectional diagram wherein measurements and relative sizes are not to scale. Accordingly the amount of tapering may be exaggerated. However it reflects the basic inventive step in this embodiment. By tapering the body 1802 the bottleneck 1603 is able to receive the body. When the body is flexible enough to be deformed and resilient enough to be forced down into the bottleneck, one may force the body 1802 into the bottleneck by for instance screwing on the bottlecap 1603 onto the bottleneck as is shown in FIG. 19. In a further embodiment the greatest outer diameter of the tapered body 1802 may be greater than the inner diameter of the bottleneck. When the body has a sufficient resilience it may not be deformed as to disappear completely into the bottleneck. A small amount of the outer diameter of the body 1904 may be left outside the bottleneck and for instance be clamped between the screwed on bottlecap and the bottleneck as is shown in FIG. 19. This may prevent the body from to be pushed involuntarily into the bottle.

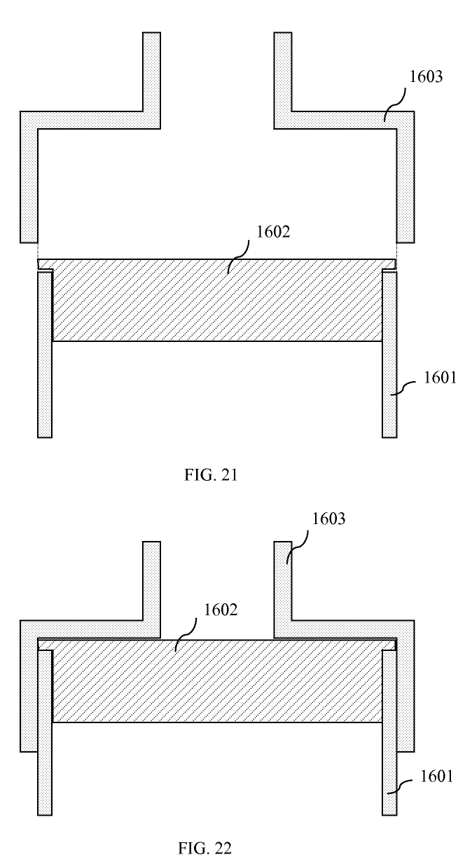

In yet another embodiment one may also provide the body 1602 with lips 1604 that form a barrier for the body to be pushed into the bottle. These lips may completely encircle the body. They may also only partially encircle the body. The lips may be part of the body. They may also be attached to the body in a separate step. In a preferred embodiment the outside diameter of the body with the lip is greater than the inside diameter of the bottleneck but smaller than the outside diameter of the bottleneck. As is shown in FIG. 21 and FIG. 22 this allows the body to be clamped between the cap and the bottleneck without being forced completely into the bottle.

In another embodiment the material of the lip may be sufficiently deformable that even when the diameter of the body with the lip is greater than the outside diameter of the bottleneck the lip may be deformed and squeezed between the bottlecap and the bottleneck.

In a further embodiment the body 1602 may be tapered so the bottleneck easily receives the body.

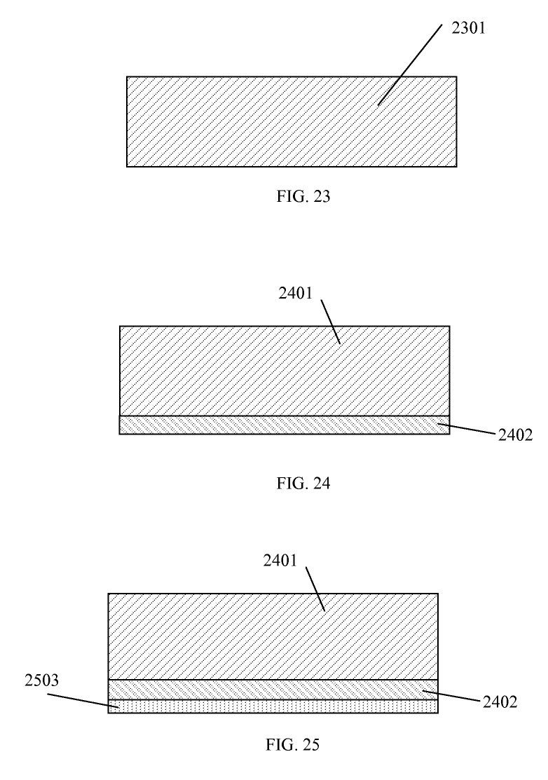

As aspects of the present invention different methods and embodiments of storing additive materials on and in the body are provided. In all of these embodiments and methods the materials may be micro-encapsulated. They may also not be micro-encapsulated. Above an embodiment was provided wherein the additive material is contained within cavities of the body. This is shown in FIG. 23 wherein 2301 is the body that may act as a filter and contains additives such as flavors or medication that may be leached out of or dissolved from the body by passing liquid.

In a further embodiment the additive material may be attached to the body as a layer to the surface of the body. This is shown in diagram in FIG. 24. Herein the body 2401 may act as a filter. It is provided by a layer 2402 of additive materials which may be micro-encapsulated. The additive materials may be in directly soluble form, or it may be in microencapsulated form. The layer preferably is provided with cavities through which liquid can stream. This allows the material in the layer to be leached or dissolved from the layer when liquid is passing through the cavities. A layer of additive materials may be attached to part of a surface, to a complete surface, to two or more surface, or to partially cover 2 or more surfaces of the body.

The layer of additive material itself in a further embodiment may be covered with a second material that has a low solubility or is insoluble. This is shown in FIG. 25 as 2503. Such a layer may be semi-permeable. This may prevent the layer of additive material 2402 from being consumed too quickly. The second material may be for instance itself be an additive for purposes including taste, medication, health and color which has a relative low solubility or may be micro-encapsulated.

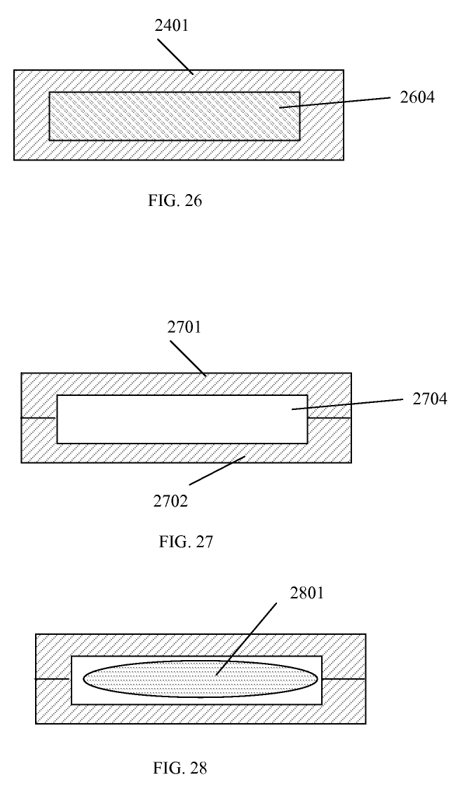

In a further embodiment the body which may act as a filter may be provided with an inside relatively large cavity which may be filled with an additive. This is shown in FIG. 26 wherein the body 2401 has a cavity 2604 which may be filled with additives. The body 2401 which may act as a filter has cavities of its own which will let liquid pass through and thus allows the additives in 2604 to be dissolved and be transported with a passing liquid for consumption. The body may in this case as in other embodiments also be provided with a layer that prevents liquid with dissolved additives to re-enter the bottle.

In a further embodiment the body with a cavity may be formed from two or more parts as in shown in FIG. 27. In the illustrative example the body has two parts 2701 and 2702 which combined together create a cavity 2704. The parts of the body may fit together and be held together through a thread or another mechanism, such as a ridge and a receiving slit. This allows the body to be filled in the open position with an additive and be firmly and safely closed for use in a bottle.

In a further embodiment one may provide the cavity 2704 with material which may be pre-packaged such as shown in FIG. 28. Such a pre-packaged form may be a pouch like permeable bag 2801 which allows its contents which may be a flavoring or any other additive and which may be dissolved into passing liquid which enters the body through its cavities.

In a further embodiment, the body may be placed in a closed bottle cap in any of the manners previously described herein. The body may have any of the features previously described, including a filter or a cavity. In accordance with this embodiment of the present invention, the closed bottle cap is removed from a bottle and the body is placed in the closed bottle cap, for example, by a friction fit as previously described. Then the bottle cap with the body inside it is placed back on the bottle. The bottle can be manipulated to cause whatever is inside the bottle, usually a liquid, to come in contact with the body. The body can interact with the fluid to remove targeted compositions or particles in the fluid or to add materials to the fluid. Once the bottle has been manipulated, the cap can be removed and the fluid inside the bottle used. For example, the fluid can be ingested or can be used in any other desired manner.

While there have been shown, described and pointed out fundamental novel features of the invention as applied to preferred embodiments thereof, it will be understood that various omissions and substitutions and changes in the form and details of the devices and kits illustrated and in its operation may be made by those skilled in the art without departing from the spirit of the invention. It is the intention, therefore, to be limited only as indicated by the scope of the claims appended hereto.

1. A retrofittable filter for a liquid filled bottle having an opening in a drinking cap, comprising:
a body that can be friction fit into the drinking cap; and
a filter operatively connected to the body to filter out material from the liquid in the body.

2. The filter as claimed in claim 1, wherein the drinking cap provided with the friction fit filter can be fastened on the liquid filled bottle.

3. The filter as claimed in claim 1, wherein the friction fit filter can be removed from the cap manually by a person of ordinary strength without exerting extraordinary force.

4. The filter as claimed in claim 1, further comprising an element containing a material that will be released from the element when exposed to a liquid.

5. The filter as claimed in claim 4, wherein the material is a flavoring material.

6. The filter as claimed in claim 4, wherein the material is a vitamin.

7. The filter as claimed in claim 4, wherein the material is a medication.

8. The filter as claimed in claim 4, wherein the material is micro-encapsulated.

9. The filter as claimed in claim 4, wherein the material is on a surface of the filter.

10. The filter as claimed in claim 4, wherein the material is impregnated in the filter.

11. The filter as claimed in claim 1, further comprising one or more additional filters and a package containing the filters.

12. A retrofittable element for a liquid filled bottle having an opening in a drinking cap, comprising:
a body that can be friction fit into the drinking cap;
a cavity in the body; and
material in the cavity that can be released into the liquid as the liquid moves through the opening in the drinking cap.

13. The element as claimed in claim 12, further comprising the body having a lip that prevents the body from entering the bottle beyond the lip.

14. The element as claimed in claim 13, wherein the lip has a diameter greater than an inside diameter of a neck of the bottle.

15. The element as claimed in claim 14, wherein the lip has a diameter not greater than an outside diameter of the neck of the bottle.

16. The element as claimed in claim 12, further comprising the body having a filter.

17. The element as claimed in claim 12, wherein the material is a flavoring material.

18. The element as claimed in claim 12, wherein the material is a vitamin.

19. The element as claimed in claim 12, wherein the material is a medication.

20. The element as claimed in claim 12, wherein the material is micro-encapsulated.

21. The element as claimed in claim 12, further comprising one or more additional elements and a package containing the elements.
